(19) United States
(12) Patent Application Publication
(10) Pub. No.: US 2021/0397872 A1
(43) Pub. Date: Dec. 23, 2021

(54) INFORMATION PROCESSING APPARATUS

(71) Applicant: FUJIFILM BUSINESS INNOVATION CORP., Tokyo (JP)

(72) Inventor: Youngkeun PARK, Kanagawa (JP)

(73) Assignee: FUJIFILM BUSINESS INNOVATION CORP., Tokyo (JP)

(21) Appl. No.: 17/114,723

(22) Filed: Dec. 8, 2020

(30) Foreign Application Priority Data
Jun. 18, 2020 (JP) 2020-105584

(51) Int. Cl. G06K 9/46; G06K 9/00; G06F 16/93

(52) U.S. Cl. CPC G06K 9/4609; G06K 9/00483; G06F 16/93; G06K 9/00463

(57) ABSTRACT

An information processing apparatus includes a processor configured to acquire first image data including update from a website which is an object to be monitored, acquire second image data from document data which is an object to be monitored, and compare the first image data with the second image data, and notify an administrator for the document data of a section with possibility of change.

### CROSS-REFERENCE TO RELATED APPLICATIONS

This application is based on and claims priority under 35 USC 119 from Japanese Patent Application No. 2020-105584 filed on Jun. 18, 2020.

### BACKGROUND

### (i) Technical Field

The present disclosure relates to an information processing apparatus.

### (ii) Related Art

Work-related documents are continuously modified. For instance, an image used for a manual is modified according to change in the screen used in actual products. In some cases, it is necessary to check a document section, such as a manual section, where modification has been made. In this case, the document after modification (hereinafter also referred to as the “latest document”) is compared with the document before modification (hereinafter also referred to as the “existing document”, and the section where modification has been made is identified. Regarding this, see, for example, Japanese Unexamined Patent Application Publication No. 2013-008147.

### SUMMARY

To identify the section where modification has been made, both the existing document and the latest document as the objects to be compared are necessary. That is, the latest document in which modification is made on the existing document is necessary.

However, the consistency required for work is not necessarily between documents having a serial relationship. For instance, consistency is also required between a website, and its operation manual, procedure manual, specifications and the like.

However, the website and the operation manual are different media, and the number of related documents is large. In addition, the relationship between the website and the existing document such as an operation manual is not the relationship between the latest document and the existing document. Therefore, even when an image in the website is modified, it is not easy to find out an image which needs modification from a corresponding document.

Aspects of non-limiting embodiments of the present disclosure relate to an image processing apparatus that reduces the burden of worker as compared with when the latest document is required to identify the sections which need to be checked.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to acquire first image data including update from a website which is an object to be monitored, acquire second image data from document data which is an object to be monitored, and compare the first image data with the second image data, and notify an administrator for the document data of a section with possibility of change.

### BRIEF DESCRIPTION OF THE DRAWINGS

Exemplary embodiments of the present disclosure will be described in detail based on the following figures, wherein:

FIG. 1 is a diagram illustrating a configuration example of an information processing system assumed in an exemplary embodiment;

FIG. 2 is a diagram illustrating a configuration example of hardware of an update management server;

FIG. 3 is a chart illustrating a functional configuration example of the update management server;

FIGS. 4A and 4B are views illustrating a website to be monitored by an image data acquisition unit, and information on acquired image data, FIG. 4A illustrates an image example of the website, and FIG. 4B illustrates an example of the acquired image data;

FIG. 5 is a view illustrating a result of comparison made by an update checker;

FIGS. 6A and 6B are views illustrating document data to be acquired by the image data acquisition unit, and information on acquired image data, FIG. 6A illustrates an example of document data, and FIG. 6B illustrates an example of the acquired image data;

FIG. 7 is a view illustrating a result of comparison made by the update checker;

FIG. 8 is a view illustrating a result of comparison between pieces of image data made by a data comparator;

FIG. 9 is a view illustrating an example of a screen displayed on a terminal of an administrator;

FIG. 10 is a view illustrating an example of comparison result data reflecting the presence or absence of instructions for modification given by an administrator;

FIG. 11 is a flowchart illustrating the processing operation performed by the update management server;

FIG. 12 is a view illustrating a list of image data acquired from a website;

FIGS. 13A and 13B are views illustrating a list of the management data of the document data managed in a document data DB, and the image data acquired from the document data DB, FIG. 13A is the management data of the document data managed in the document data DB, and FIG. 13B is a list of acquired image data;

FIG. 14 is a view illustrating an example of a result of comparison between the image data acquired in a website and the image data acquired in document data;

FIG. 15 is a view illustrating an example of a result of receiving the necessity or unnecessity of update of image data determined by an administrator;

FIG. 16 is a view illustrating an example of acquired image data when the image data is acquired from the website for the second and subsequent time;

FIG. 17 is a view illustrating an example of acquired image data when the image data is acquired from document data for the second and subsequent time;

FIG. 18 is a view illustrating an example of management data registered according to checking by an administrator in the previous time;

FIG. 19 is a view illustrating an example of a result of comparison between the image data acquired in a website and the image data acquired in document data; and

FIG. 20 is a view illustrating an example of a result of receiving the necessity or unnecessity of update of image data determined by an administrator.

### DETAILED DESCRIPTION

Hereinafter, an exemplary embodiment will be described in detail with reference to the accompanying drawings.

### Exemplary Embodiment

### <System Configuration>

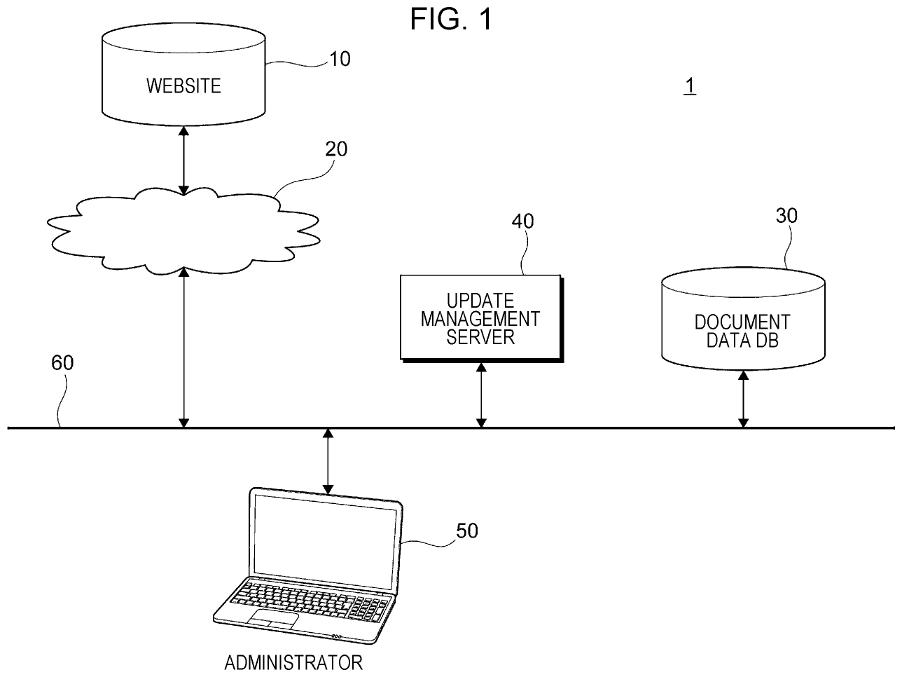

FIG. 1 is a diagram illustrating a configuration example of an information processing system 1 assumed in an exemplary embodiment.

The information processing system 1 illustrated in FIG. 1 is configurated by a website 10 to be monitored; Internet 20; database (hereinafter referred to as “document data DB”) 30 of the document data related to the object to be monitored; an update management server 40; a terminal 50 operated by an administrator; and a local area network (LAN) 60.

The website 10 in the exemplary embodiment refers to image data which is assigned an address on the World Wide Web (WWW), and accessible from an external device. Therefore, the location where the website 10 resides is not restricted to the server, and may also be a device or a machine which can communicate with the outside.

The website 10 in the exemplary embodiment also includes the image of the control panel of a machine, an image for checking displayed according to version-up of an operating system or a firmware, and the image of the user interface of application software.

In the case of FIG. 1, the website 10 resides on the Internet 20, but may reside on the LAN 60.

The document data DB 30 is a storage that stores the document data related to the website 10 which is an objected to be monitored. In the case of FIG. 1, the document data DB 30 resides on the LAN 60, but may reside on the Internet 20. In the exemplary embodiment, the document data is, for instance, an operation manual, a procedure manual, and specifications.

The update management server 40 provides the functions of monitoring update of an image in the website 10, detecting an image with high need of correction among related document data, and notifying an administrator of the image. The update management server 40 is an example of an information processing apparatus.

The terminal 50 is a so-called computer, and assumed to be a desktop computer or a notebook computer. In fact, the terminal 50 may also be a smartphone or a tablet terminal.

### <Configuration of Update Management Server 40>

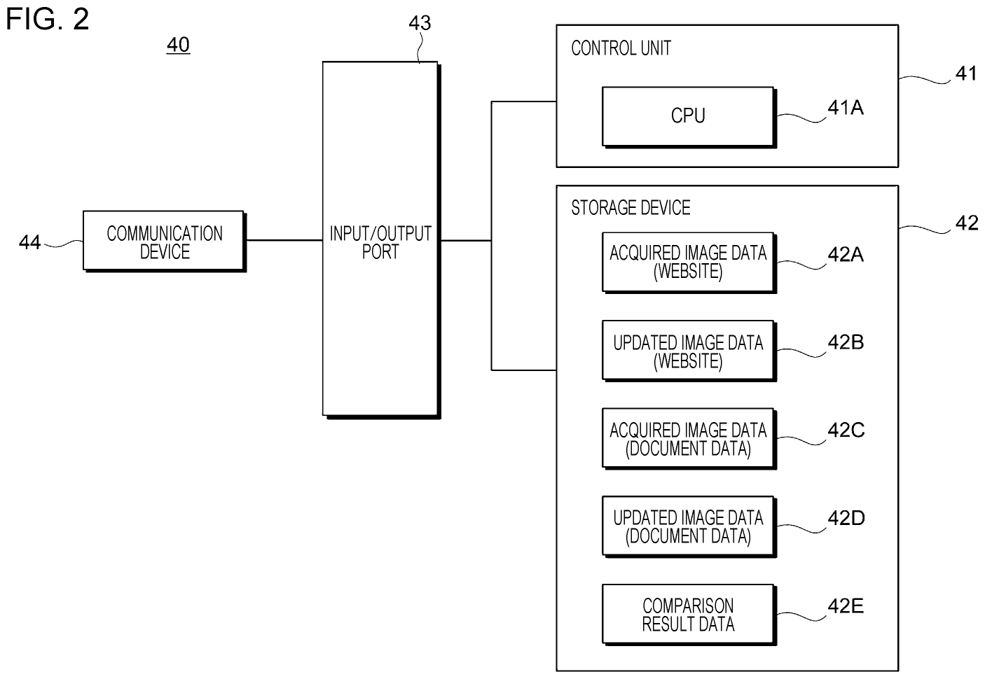

FIG. 2 is a diagram illustrating a configuration example of hardware of the update management server 40.

The update management server 40 has a control unit 41 that controls the operation of the entire apparatus, a storage device 42 that stores data, an Input/Output port 43, and a communication device 44.

The control unit 41 has a central processing unit (CPU) 41A, a read only memory (ROM) which stores the Basic Input Output System (BIOS) and the like, and a random access memory (RAM) used as a work area. The control unit 41 functions as a so-called computer. The CPU 41A is an example of a processor.

The storage device 42 is configurated by a semiconductor memory and a hard disk drive, for instance. The storage device 42 stores an operating system and a program which implements the functions proposed in the exemplary embodiment.

In addition, the storage device 42 in the exemplary embodiment stores the image data (hereinafter referred to as “acquired image data”) 42A acquired from the website 10 (see FIG. 1), the image data (hereinafter referred to as “updated image data”) 42B for which possibility of update from the previously acquired image data 42A to the latest acquired image data 42A is identified, the image data (hereinafter referred to as “acquired image data”) 42C acquired from the document data DB 30 (see FIG. 1), the image data (hereinafter referred to as “updated image data”) 42D for which possibility of update from the previously acquired image data 42C to the latest acquired image data 42C is identified, and a result of comparison (hereinafter referred to as “comparison result data”) 42E between an image on the website 10 where update has been detected, and an image in the document data.

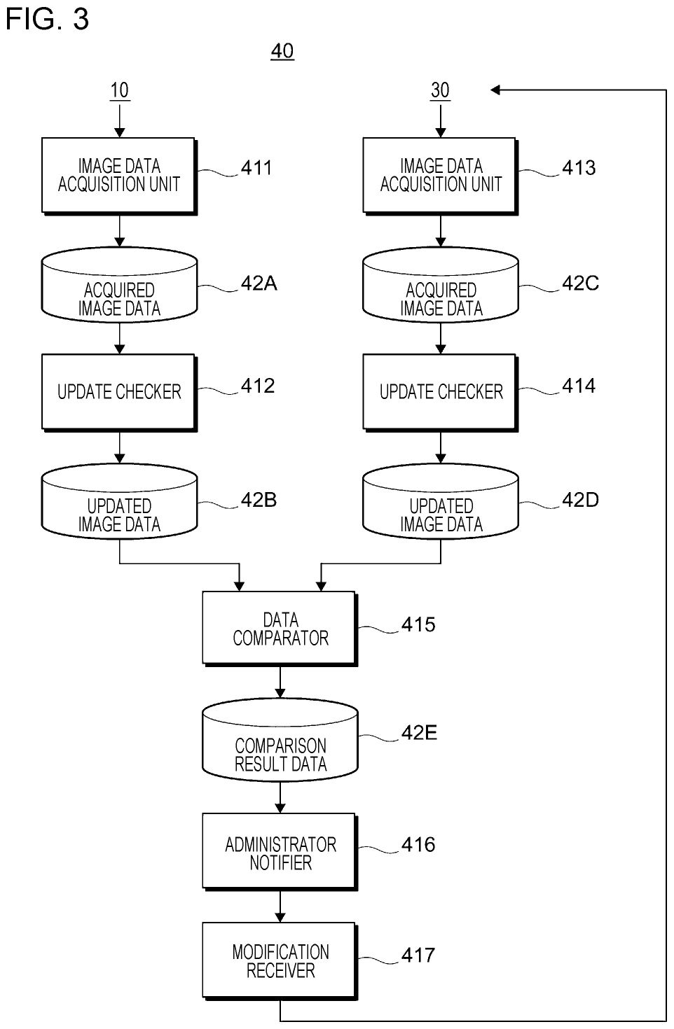

FIG. 3 is a chart illustrating a functional configuration example of the update management server 40. The functional configuration illustrated in FIG. 3 is implemented by executing a program.

As the functional units, the update management server 40 has an image data acquisition unit 411 that acquires image data from the website 10, an update checker 412 that checks image data with a high possibility of update from the acquired image data 42A, an image data acquisition unit 413 that acquires image data from the document data DB 30, an update checker 414 that checks image data with a high possibility of update from the acquired image data 42C, a data comparator 415 that compares the updated image data 42B acquired from the website 10 with the updated image data 42D acquired from the document data, an administrator notifier 416 that notifies an administrator of the presence of image data with a high possibility of update from the comparison result data 42E, and a modification receiver 417 that receives a result of checking of the image data notified by the administrator and modification instructions given by the administrator.

The acquired image data 42A is an example of first image data, and the acquired image data 42C is an example of second image data.

The image data acquisition unit 411 acquires the image data included in the specific website 10 designated by the administrator as an object to be monitored. The website 10 as an object to be monitored is designated by a uniform resource locator (URL), or URL under a domain. As described above, the website also includes the images of the control panel and the like of a machine. It is to be noted that the URL may be acquired from a source code or the like used in development. Alternatively, the administrator may designate part of the acquired URL in advance as an object to be monitored.

The specific website 10 may be identified by the type of the site, a company name, a service name or the like in addition to by individual designation.

It is to be noted that the image data acquisition unit 411 may be application software (hereinafter referred to as a “bot”) that automatically collects image data from the Internet.

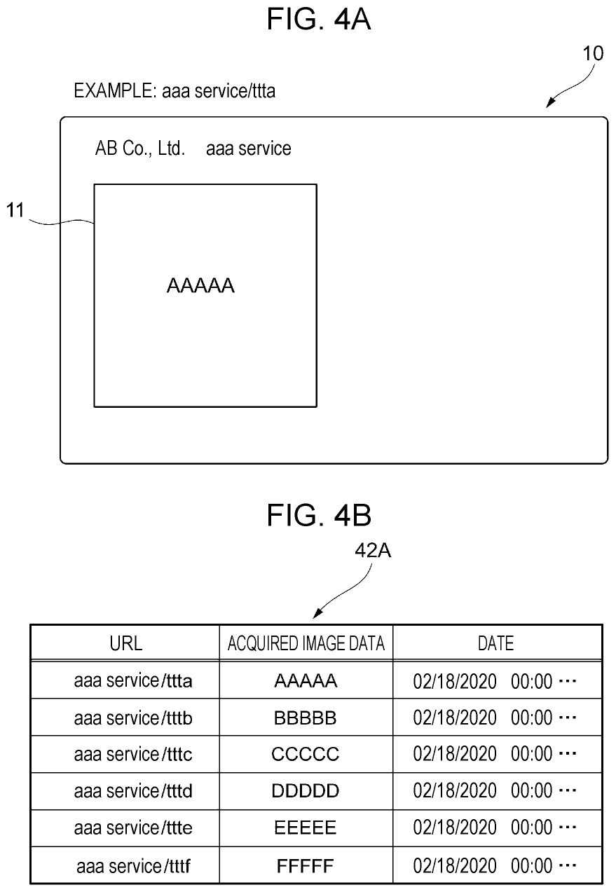

FIGS. 4A and 4B are views illustrating the website 10 to be monitored by the image data acquisition unit 411 (see FIG. 3), and information on acquired image data. FIG. 4A illustrates an image example of the website 10, and FIG. 4B illustrates an example of the acquired image data 42A. FIG. 4A shows the website 10 identified by “aaa service/ttta”.

The image data acquisition unit 411 acquires “AAAAA” image 11 included in the website 10.

The example of FIG. 4B assumes that one image is included in one page of the website 10, but multiple images may be included in one page. In that case, a different name is assigned to each image data and managed.

As illustrated in FIG. 4B, the acquired image data 42A is associated with a URL to identify the website 10 which is the origin of acquisition and the date of acquisition. In the case of FIG. 4, the date provides the date and time. In the exemplary embodiment, the image data acquisition unit 411 acquires image data once a day from the website 10 which is an object to be monitored. It is to be noted that once a day is an example, and image data may be acquired once every hour or once every several hours.

The description is returned to FIG. 3.

The update checker 412 provides the functions of comparing the latest image data with the image data acquired at the immediately previous time, and checking whether image data has been updated in the period from the acquisition at the immediately previous time to the acquisition at the current time.

In the exemplary embodiment, the update checker 412 uses a matching rate to determine the presence or absence of update. A matching rate of 100% indicates that two images completely match, and a matching rate of 0% indicates that two images are totally different. The matching rate when part of an image has changed takes an intermediate value between 100% and 0% according to the number of changes.

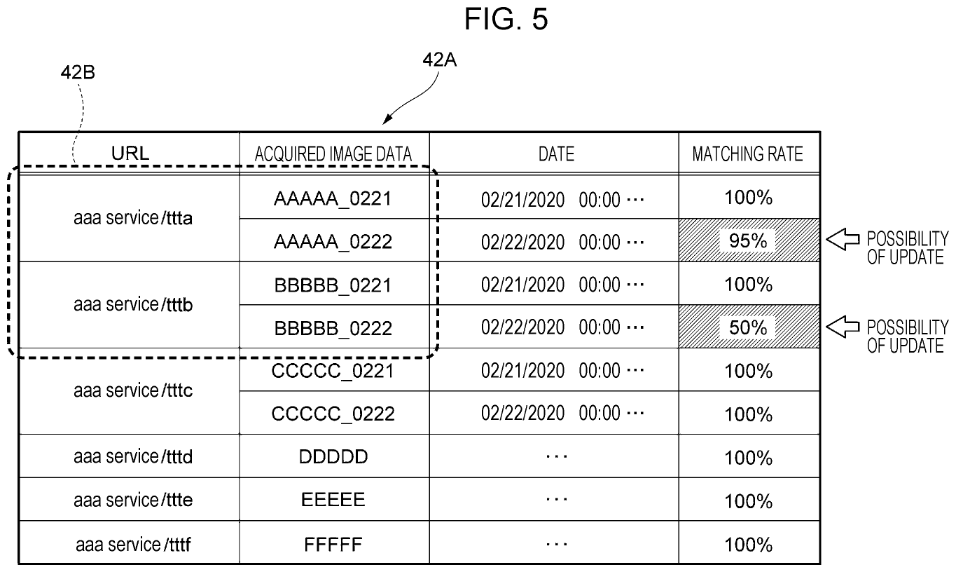

FIG. 5 is a view illustrating a result of comparison made by the update checker 412 (see FIG. 3). The example illustrated in FIG. 5 shows the result of comparison for each of the website 10 identified by “aaa service/ttta”, the website 10 identified by “aaa service/tttb”, and the website 10 identified by “aaa service/tttc”. It is to be noted that although omitted in FIG. 5, the result of comparison for the remaining three websites 10 also exists similarly.

In the case of FIG. 5, the file name of the acquired image data 42A acquired from the same website 10 is appended with information on the date.

In the case of FIG. 5, two pieces of acquired image data 42A for one website 10 are stored. One is the acquired image data 42A acquired on February 21, and the other is the acquired image data 42A acquired on February 22.

In the case of FIG. 5, for the website 10 identified by “aaa service/ttta”, the matching rate between “AAAAA_0221” image acquired on February 21 and “AAAAA_0220” image acquired on the previous day is 100%.

However, the matching rate between “AAAAA_0222” image acquired on February 22 and the “AAAAA_0221” image acquired on the previous day has been reduced to 95%. The matching rate here corresponds to the “agreement rate”.

Similarly, for the website 10 identified by “aaa service/tttb”, the matching rate between “BBBBB_0221” image acquired on February 21 and “BBBBB_0220” image acquired on the previous day is 100%.

However, the matching rate between “BBBBB_0222” image acquired on February 22 and the “BBBBB_0221” image acquired on the previous day has been reduced to 50%.

Therefore, the update checker 412 outputs the “AAAAA_0222” image and the “BBBBB_0222” image as the updated image data 42B.

It is to be noted that a threshold may be used for the matching rate to determine update. For instance, the threshold is set to 96%. This is because the possibility of error in matching is considered. 96% here is an example of a first threshold.

When there is no possibility of update for any of the acquired image data 42A, the update checker 412 terminates the processing without outputting updated image data 42B.

The description is returned to FIG. 3.

The image data acquisition unit 413 acquires image data from the document data stored in the document data DB 30. The document data to be monitored is provided by designating in advance the document data related to the website which is an object to be acquired by the image data acquisition unit 411. Alternatively, all document data stored in the document data DB 30 may be an object to be monitored.

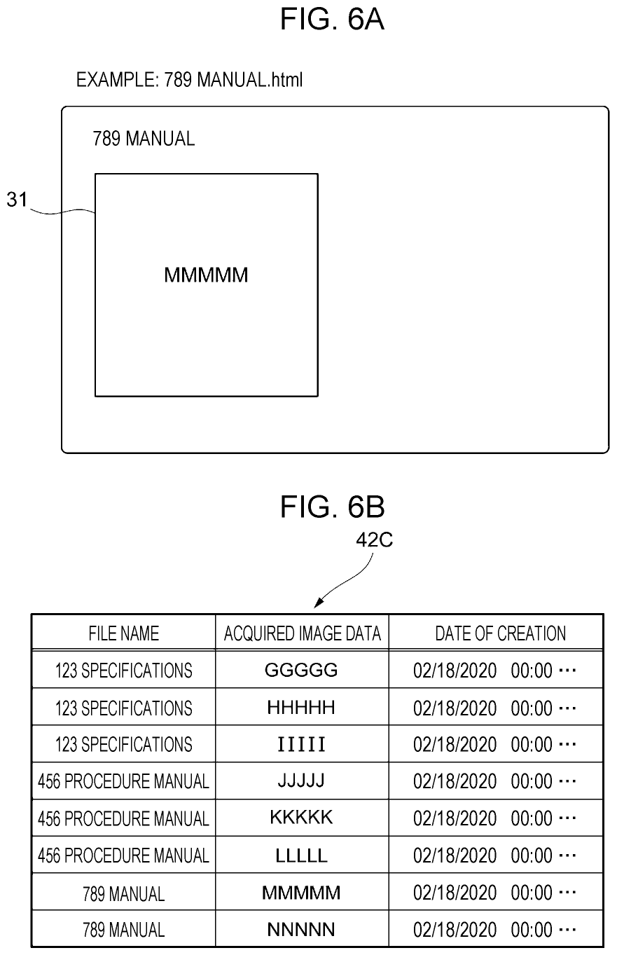

FIGS. 6A and 6B are views illustrating document data to be acquired by the image data acquisition unit 413 (see FIG. 3), and information on acquired image data. FIG. 6A illustrates an example of document data, and FIG. 6B illustrates an example of the acquired image data 42C.

The file name of the document data exemplified in FIG. 6A is “789 manual.html”. The image data acquisition unit 413 acquires “MMMMM” image 31 included in the “789 manual”.

In the example of FIG. 6B, three pieces of image data are acquired from “123 specifications”, three pieces of image data are acquired from “456 procedure manual”, and two pieces of image data are acquired from the “789 manual”.

As illustrated in FIG. 6B, the acquired image data 42C is associated with the file name to identify each document data and the date of acquisition. In the case of FIG. 6, the date of creation provides the date and time. In the exemplary embodiment, the image data acquisition unit 413 acquires image data when the document data is updated.

The description is returned to FIG. 3.

The update checker 414 provides the functions of comparing the latest image data with the image data acquired at the immediately previous time, and checking whether image data has been updated in the period from the acquisition at the immediately previous time to the acquisition at the current time.

The update checker 414 also uses a matching rate to determine the presence or absence of update. A matching rate of 100% indicates that two images completely match, and a matching rate of 0% indicates that two images are totally different. The matching rate when part of an image has changed takes an intermediate value between 100% and 0% according to the number of changes. It is to be noted that less than 5% may be regarded as substantially 0% in consideration of an error. 5% here is an example of a second threshold.

The update checker 414 aims to acquire the latest image data of the document data.

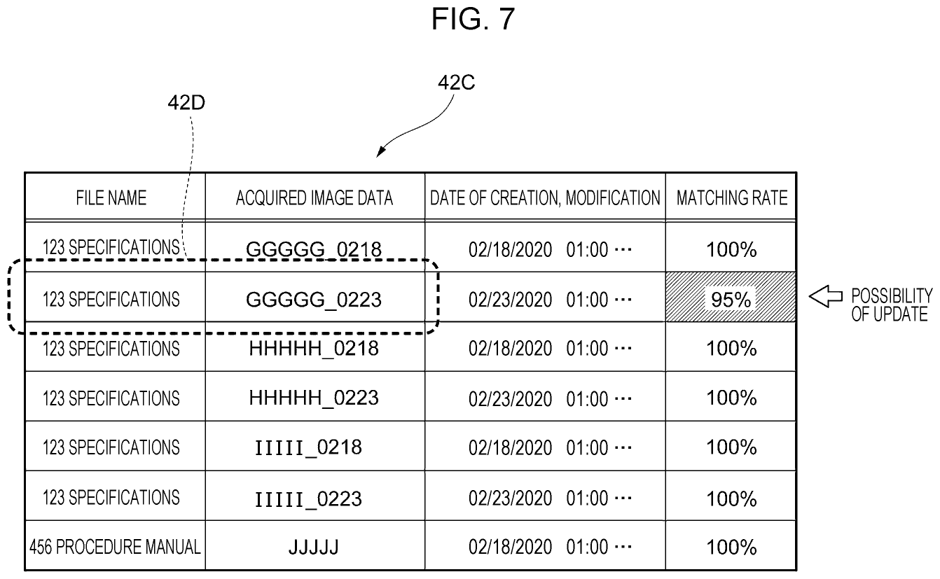

FIG. 7 is a view illustrating a result of comparison made by the update checker 414. In the case of FIG. 7, the file name of the acquired image data 42C acquired from the same document data is appended with information on the date of creation or modification and a matching rate.

In the case of FIG. 7, for the “123 specifications”, the matching rate between “GGGGG_0218” image acquired on February 18 and the image (not illustrated) acquired at the previous time is 100%. However, the matching rate between “GGGGG_0223” image acquired on February 23 and the GGGGG_0218″ image acquired at the previous time has been reduced to 95%.

It is to be noted that a threshold may be used for the matching rate to determine update. The threshold for providing an upper limit is set to 96%, for instance. The possibility of inclusion of a banner in the image data acquired as a snapshot is considered.

When there is no possibility of update for any of the acquired image data 42C, the update checker 414 terminates the processing without outputting the updated image data 42D.

The description is returned to FIG. 3.

The data comparator 415 compares the updated image data 42B checked for the website 10 with the updated image data 42D checked for the document data, and outputs a result of the comparison. In the exemplary embodiment, a matching rate is outputted as a result of the comparison.

In the exemplary embodiment, both a threshold providing an upper limit and a threshold providing a lower limit are used. The threshold providing an upper limit is an example of the first threshold, and is used for the purpose of removing image data with a reduced matching rate due to banners or the like. The threshold providing a lower limit is an example of the second threshold, and is used to prevent update to a totally different image.

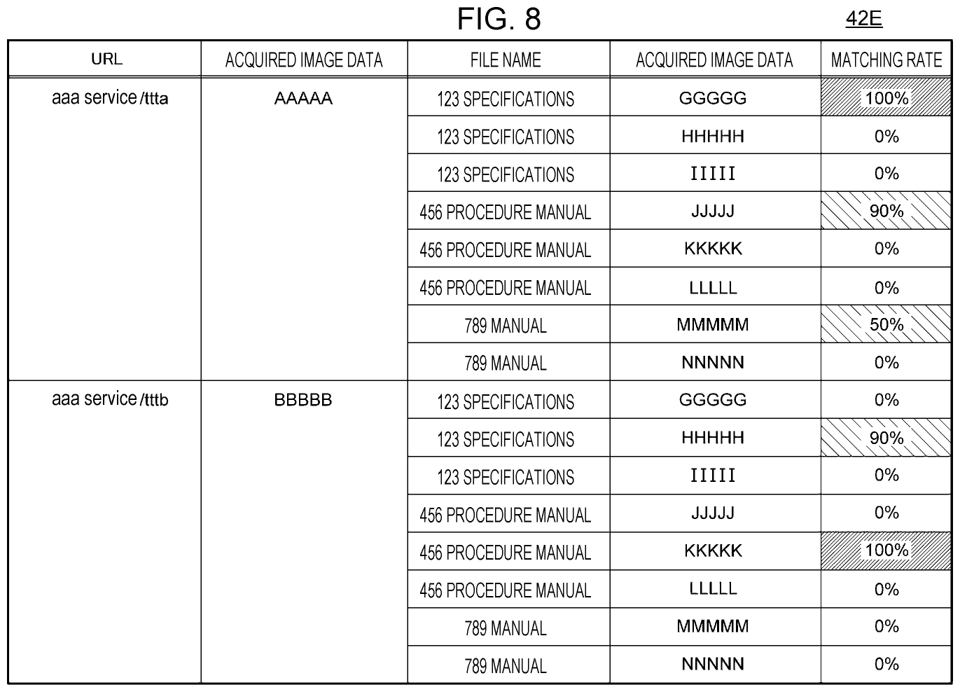

FIG. 8 is a view illustrating a result of comparison between pieces of image data made by the data comparator 415 (see FIG. 3).

In the case of FIG. 8, the “AAAAA” image acquired from the website 10 is compared with each of “GGGGG” image, “HHHHH” image, and “IIIII” image included in the document data “123 specifications”; “JJJJJ” image, “KKKKK” image, and “LLLLL” image included in the document data “456 procedure manual”; and “MMMMM” image and “NNNNN” image included in the document data “789 manual”.

In the case of FIG. 8, the matching rate between the “AAAAA” image acquired from the website 10 and the “GGGGG” image acquired from the “123 specifications” is 100%.

Also, the matching rate between the “AAAAA” image acquired from the website 10 and each of “HHHHH” image and “IIIII” image included in the “123 specifications”, “KKKKK” image and “LLLLL” image included in the “456 procedure manual”, and “NNNNN” image included in the “789 manual” is 0%.

Note that the matching rate between the “AAAAA” image acquired from the website 10 and the “JJJJJ” image included in the “456 specifications” is 90%, and the matching rate between the “AAAAA” image acquired from the website 10 and the “MMMMM” image included in the “789 manual” is 50%.

Also, the matching rate between “BBBBB” image acquired from website 10 and the “HHHHH” included in the “123 specifications” is 90%.

The description is returned to FIG. 3.

The administrator notifier 416 is a functional unit that notifies the administrator's terminal 50 (see FIG. 1) of image data with a matching rate which needs to be checked by the administrator.

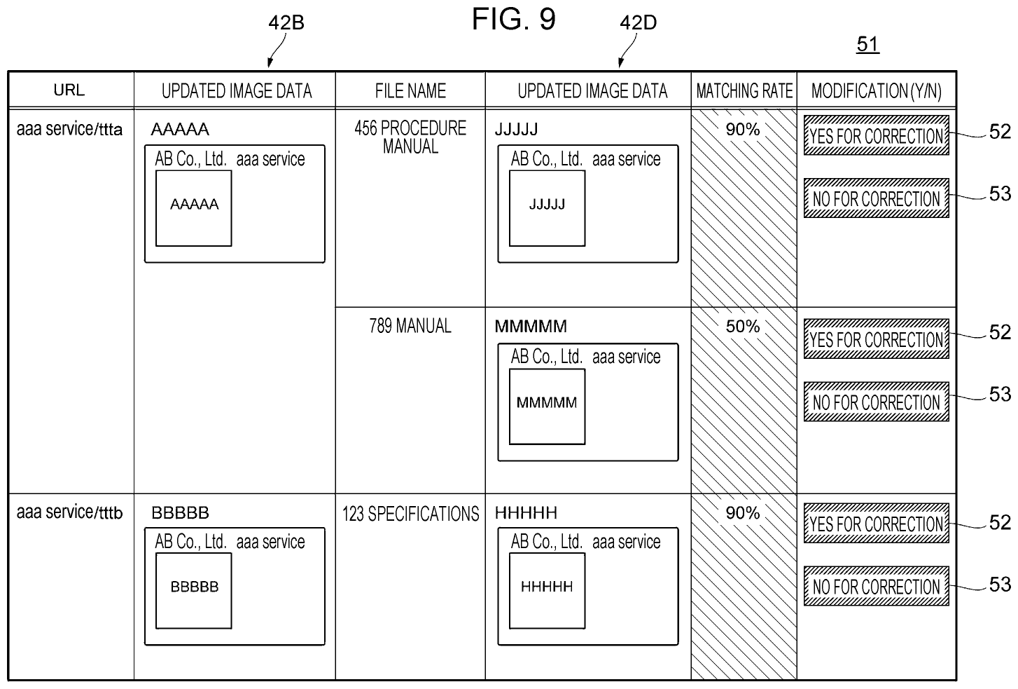

FIG. 9 is a view illustrating an example of a screen 51 displayed on the terminal 50 of the administrator.

On the screen 51 illustrated in FIG. 9, the “JJJJJ” image of the “456 procedure manual”, having a matching rate of 90% with the “AAAAA” image of the website 10; the “MMMMM” image of the “789 manual”, having a matching rate of 50% with the “AAAAA” image of the website 10; and the “HHHHH” image of the “123 specifications”, having a matching rate of 90% with the “BBBBB” image of the website 10 are displayed side by side.

The “AAAAA” image and the “BBBBB” image are the updated image data 42B of the website 10, and the “JJJJJ” image, the “MMMMM” image, and the “HHHHH” image are the updated image data 42D of the document data.

In the case of FIG. 9, columns are arranged to input the numerical value of a matching rate associated with a corresponding image, and necessity or unnecessity of modification for corresponding document data. In FIG. 9, the title of “modification (Y/N)” is displayed in the column to input necessity or unnecessity of modification, and in the column, a button 52 labeled with “YES for modification” and a button 53 labeled with “NO for modification” are displayed.

The administrator determines the necessity or unnecessity of modification while checking the actual image, and operates the button 52 or the button 53.

The description is returned to FIG. 3.

The modification receiver 417 is a functional unit that receives a modification request for the updated image data 42D for which the administrator has selected “YES for modification”.

It is to be noted that when the updated image data 42D of corresponding document data is not modified although the administrator has selected “YES for modification”, the modification receiver 417 notifies the administrator of a reminder email for the modification via the administrator notifier 416.

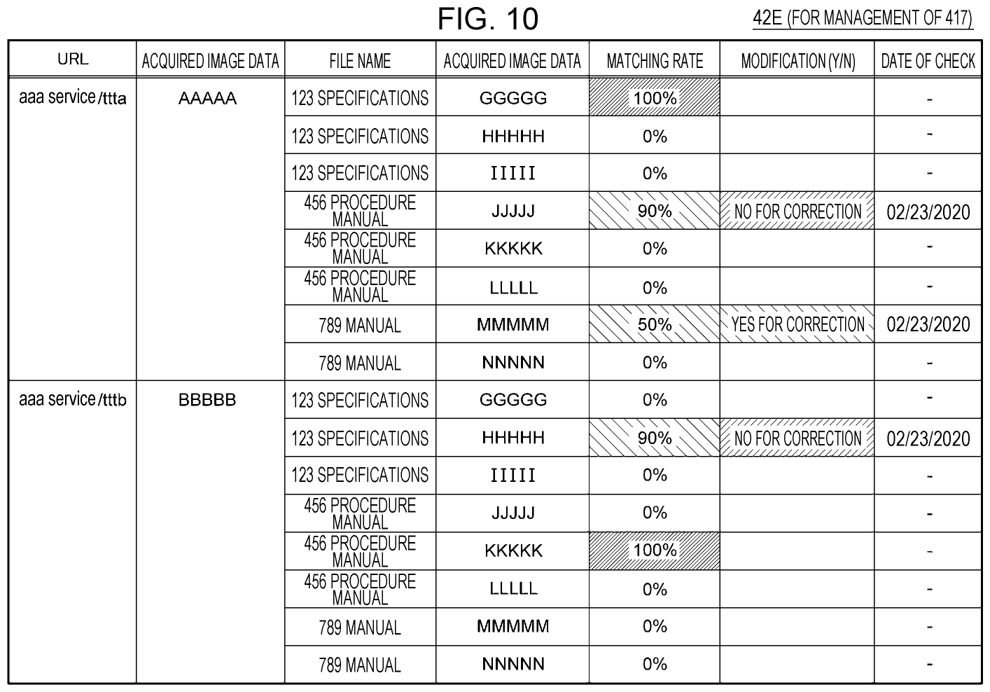

FIG. 10 is a view illustrating an example of the comparison result data 42E which reflects the presence or absence of instructions for modification given by the administrator. The comparison result data 42E illustrated in FIG. 10 corresponds to the comparison result data 42E illustrated in FIG. 8.

The comparison result data 42E illustrated in FIG. 10 is for management of the modification receiver 417. In the case of FIG. 10, “YES for modification” is recorded only for the “MMMMM” image of the “789 manual”, and “NO for modification” is recorded for the “JJJJJ” image of the “456 procedure manual” and the “HHHHH” image of the “123 specifications”.

For each of the images, the date of check by the administrator is “02/23/2020”.

In the case of FIG. 10, “NO for modification” is recorded for the “JJJJJ” image and the “HHHHH” image, which is a result of determination made by the administrator that modification is not necessary substantially.

For instance, image data acquired from the website 10 is obtained as a snapshot at a certain moment. Thus, when a banner ad or the like having variable position and content with time is displayed on the “AAAAA” image or the “BBBBB” image of the website 10 in an overlapping manner, the matching rate may be reduced.

However, it is possible that image data displayed behind a banner ad or the like, and image data in the document data may be the same. “NO for modification” of FIG. 10 represents such an example.

When receiving instructions for “YES for modification”, the modification receiver 417 gives instructions for acquisition again to the image data acquisition unit 411 that acquires image data from the website 10 and the image data acquisition unit 413 that acquires image data from the document data DB 30, and repeats a series of comparisons.

When a user modifies the document data to obtain correct image data, the matching rates of all image data reach 100% in the second checking, and the loop processing is completed.

### <Processing Operation>

Hereinafter, the processing operation performed in the information processing system 1 assumed in the exemplary embodiment will be described.

In the following, the operation (hereinafter referred to as the “first operation”) when a program to check update is executed for the first time and the operation for the second and subsequent time will be described.

### <First Operation>

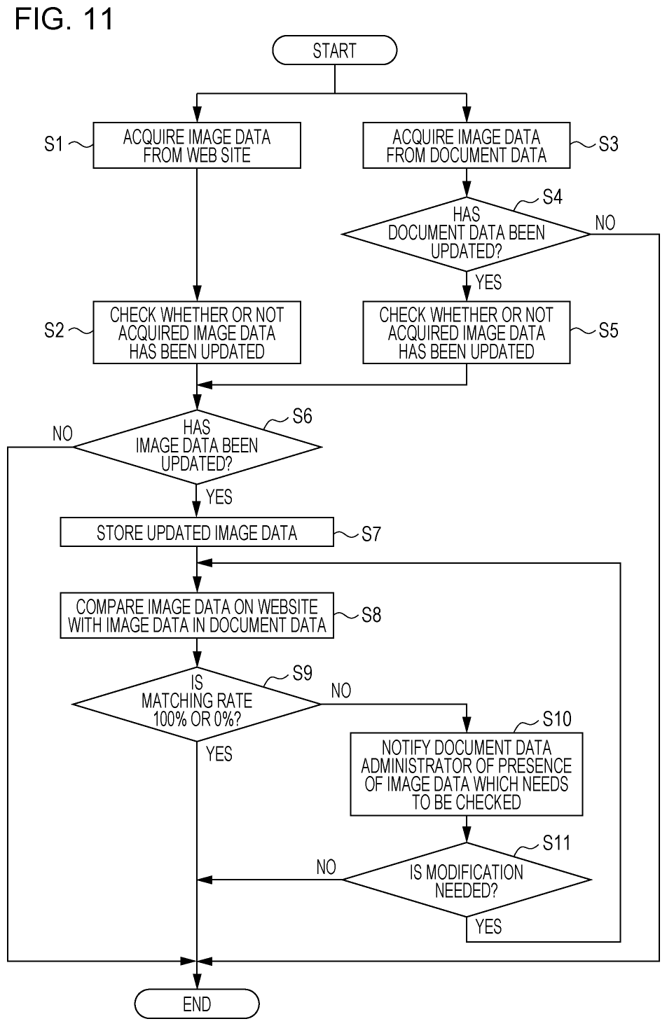

FIG. 11 is a flowchart illustrating the processing operation performed by the update management server 40. The symbol S shown in FIG. 11 represents Step.

The CPU 41A (see FIG. 2) which has started the processing acquires image data from the website 10 (step 1).

In the exemplary embodiment, the image data refers to data having a data format of Joint Photographic Experts Group (JPEG), Portable Network Graphics (PNG), or Graphics InterchangeFormat (GIF), for instance.

The range in which the CPU 41A acquires image data from the website 10 is set, for instance, by an administrator, Mr. D using the terminal 50 (see FIG. 1).

The administrator, Mr. D sets the acquisition range, for instance, for a new service A. The designation of the range is made, for instance, by “www.fujixerox.co.jp/aaa service/ttt*”, where indicates any letter. Therefore, all websites identified by “ttt*” of “aaa service” are included in the range for search.

The CPU 41A accesses the designated websites 10 regularly, and acquires image data included in each website 10. For instance, image data is acquired once a day.

When acquiring image data, the CPU 41A checks the presence or absence of update for the acquired image data (step 2), and subsequently, determines whether or not the image data has been updated (step 6).

Since the current processing operation is the first operation, the CPU 41A obtains an affirmative result in step 6. When an affirmative result is obtained, the CPU 41A saves the image data which has been updated (step 7). In the current case, the CPU 41A saves all image data acquired from the website 10.

It is to be noted that when a negative result is obtained in step 6, the CPU 41A terminates the processing.

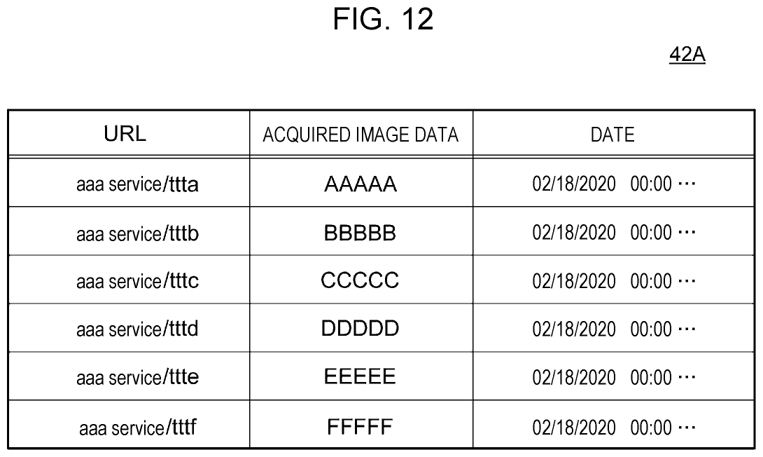

FIG. 12 is a view illustrating a list of image data (in other words, the acquired image data 42A) acquired from the website 10. In the case of FIG. 12, six pieces of image data have been acquired from the website 10 which is set for the “aaa service”.

The description is returned to FIG. 11.

Concurrently with step 1, the CPU 41A acquires image data from the document data in the document data DB 30 (step 3).

The range in which the CPU 41A acquires image data from the document data DB 30 is also set, for instance, by the administrator, Mr. D using the terminal 50. The administrator, Mr. D sets, for instance, the “management folder” of the document data DB 30 as a location to acquire image data. It is to be noted that the administrator, Mr. D also sets the time when comparison is made between the image data acquired from the website 10 and the image data acquired from the document data. For instance, the time is set to 1:00 a.m. everyday.

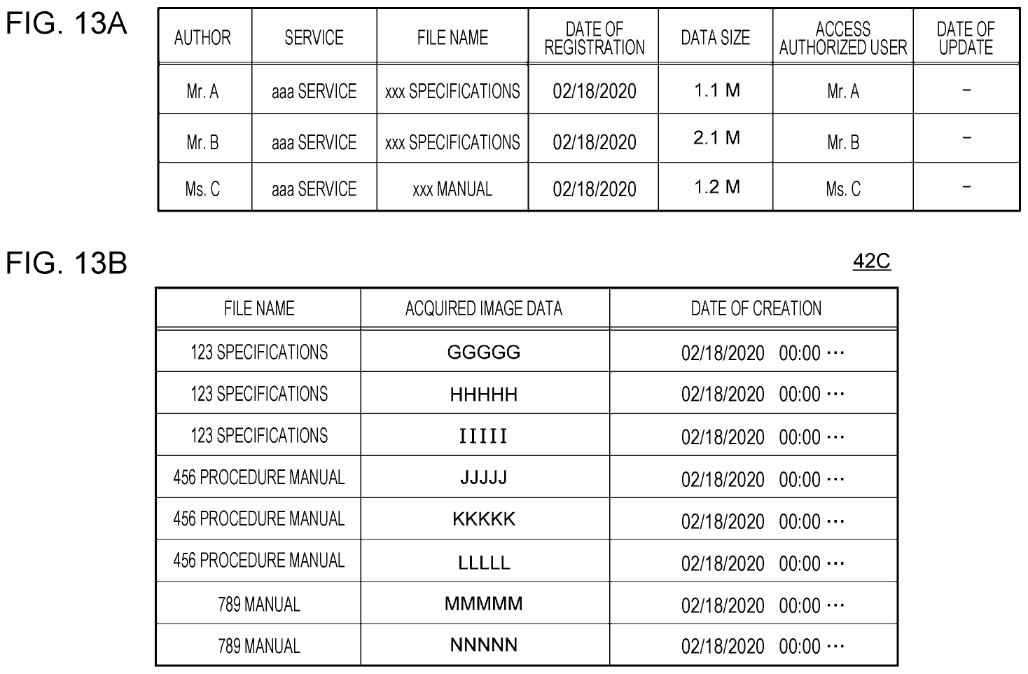

FIGS. 13A and 13B are views illustrating a list of management data of the document data managed in the document data DB 30, and the image data (in other words, the acquired image data 42C) acquired from the document data DB 30. FIG. 13A is the management data of the document data managed in the document data DB 30, and FIG. 13B is a list of the acquired image data 42C.

The management data illustrated in FIG. 13 is configurated by author who created document data, service related to the document data, file name, date of registration, data size, access authorization, and date of update. In the case of FIG. 13, the document data related to the “aaa service” is the object to be managed.

The acquired image data 42C illustrated in FIG. 13 is configurated by file name, acquired image data, and date of creation. In the case of FIG. 13, eight pieces of image data are acquired from the “management folder” related to the “aaa service”.

The description is returned to FIG. 11. When acquiring image data from the document data, the CPU 41A determines whether or not the document data has been updated (step 4).

Since the current processing operation is the first operation, the CPU 41A obtains an affirmative result in step 4. It is to be noted that when a negative result is obtained in step 4, the CPU 41A terminates the processing for the document data.

When an affirmative result is obtained in step 4, the CPU 41A checks the presence or absence of update for the acquired image data (step 5), and subsequently, determines whether or not the image data has been updated (step 6).

Since the current processing operation is the first operation, the CPU 41A obtains an affirmative result in step 6. When an affirmative result is obtained, the CPU 41A saves the image data which has been updated (step 7). In the current case, the CPU 41A saves all image data acquired from the document data.

Because of the determination, the image data acquired from the document data is always maintained at the latest state.

Next, the CPU 41A compares the image data of the website 10 with the image data of the document data (step 8).

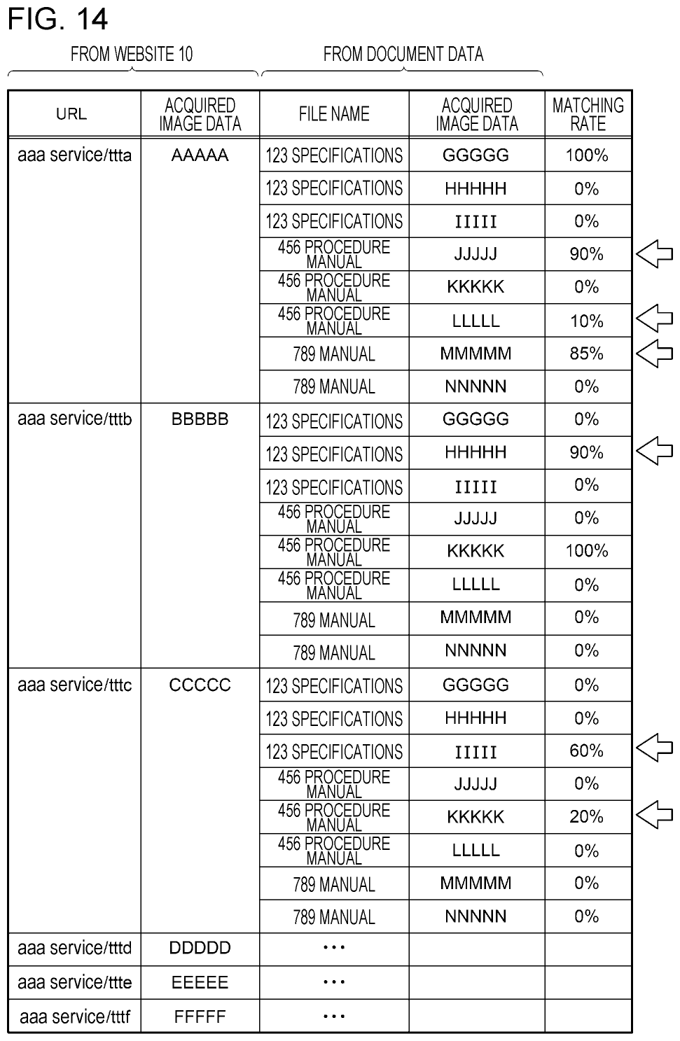

FIG. 14 is a view illustrating an example of a result of comparison between the image data acquired in the website 10 and the image data acquired in the document data.

The example illustrated in FIG. 14 shows a result of comparison between six pieces of image data acquired from the website 10 and eight pieces of image data acquired from the document data. It is to be noted that FIG. 14 exemplifies a result of comparison for three pieces of image data out of the six pieces of image data acquired from the website 10, and a result of comparison for the other three pieces of image data is omitted.

In FIG. 14, the matching rate is 100% or 0% except for the rows indicated by an arrow. A matching rate of 100% indicates that two images completely match. On the other hand, a matching rate of 0% indicates that two images are totally different.

In either case, it is not necessary to request the administrator of the document data to check for update of image data in the document data.

In the example of FIG. 14, three pieces of document data in the “AAAAA” image of the “aaa service/ttta” are each labeled with an arrow. One piece of document data in the “BBBBB” image of “aaa service/tttb” is labeled with an arrow. Two pieces of document data in the “CCCCC” image of “aaa service/tttc” are each labeled with an arrow.

The description is returned to FIG. 11.

When the comparison in step 8 is completed, the CPU 41A determines whether the matching rate is 100% or 0% (step 9).

When the matching rates for all results of comparison are 100 or 0%, the CPU 41A obtains an affirmative result, and terminates a series of processing. This is because it is not necessary to request the administrator of the document data to check for update.

It is to be noted that when a negative result obtained in step 9, the CPU 41A notifies the administrator for the document data of the existence of image data which needs to be checked (step 10). The notification is transmitted to the terminal 50 of the administrator as an E-mail, for instance.

Subsequently, the CPU 41A determines whether modification is needed using the notification from the terminal 50 of the administrator (step 11). When necessity of modification is not indicated, the CPU 41A obtains a negative result in step 11, and terminates a series of processing.

When an affirmative result is obtained in step 11, the CPU 41A returns to step 8, and compares the updated image data with the image data in the website 10 again. Thus, necessity or unnecessity of modification can be checked.

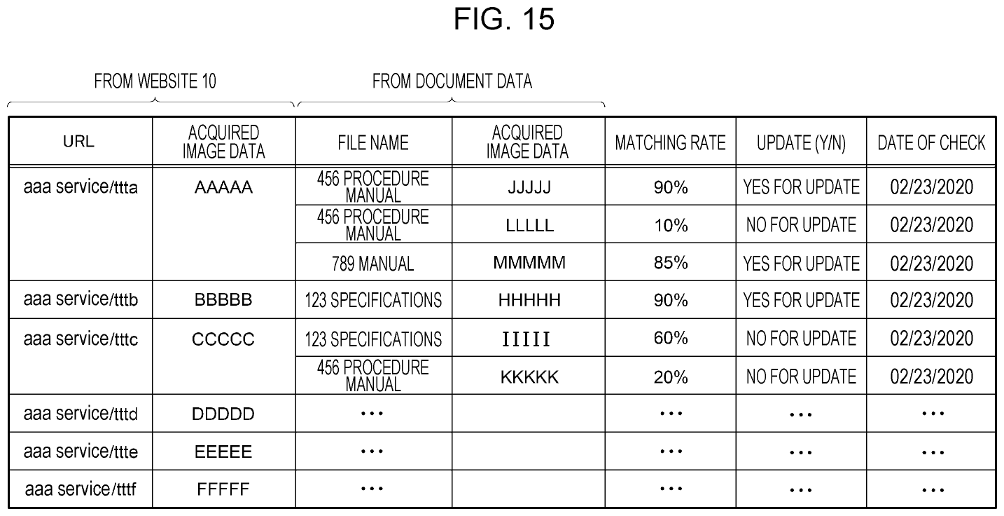

FIG. 15 is a view illustrating an example of a result of receiving the necessity or unnecessity of update of image data determined by an administrator.

In the case of FIG. 15, “YES for modification” is selected for three pieces of image data: the “JJJJJ” image of the “456 procedure manual”, the “MMMMM” image of the “789 manual”, and the “HHHHH” image of the “123 specifications”. “NO for modification” is selected for the other three pieces of image data.

### <Operation at Second and Subsequent Time>

In the following, the processing operation for image data from the website 10 for the second and subsequent time will be described. The processing operation is also performed based on the flowchart illustrated in FIG. 11.

In the processing operation, the CPU 41A (see FIG. 2) acquires image data from the website 10 (step 1).

In the current case, when image data with updated from the previous time is determined in the step 2, and updated image data is found, an affirmative result is obtained in step 6, and the updated image data 42B is stored.

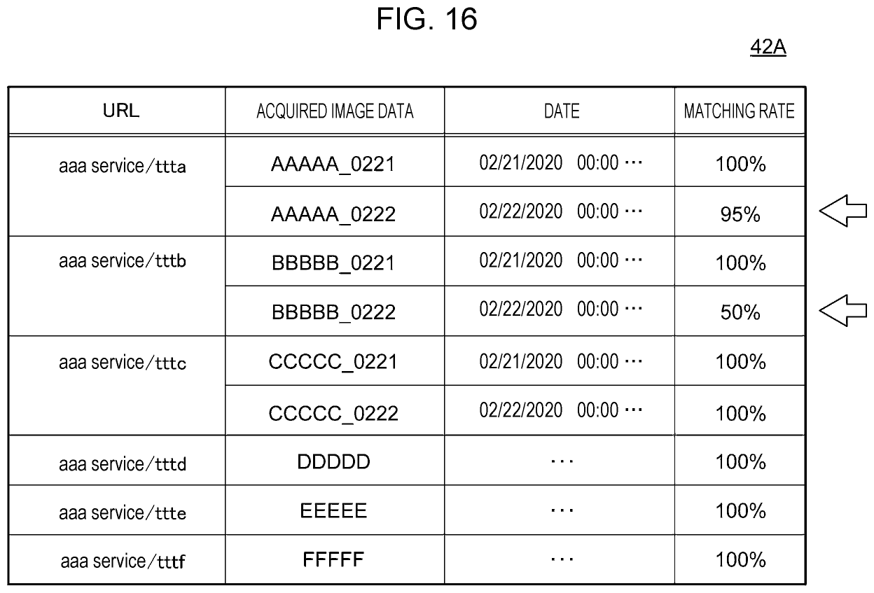

FIG. 16 is a view illustrating an example of the acquired image data 42A when the image data is acquired from the website 10 for the second and subsequent time. In FIG. 16, a corresponding symbol is labeled and shown for a corresponding portion with FIG. 12.

In the case of FIG. 16, it is assumed that part of the websites of the “aaa service” are updated on “02/22/2020” which is one day after the previous acquisition, and the other websites are not updated.

It is to be noted that whether or not the website 10 has been updated is not determined. Thus, all pieces of image data are acquired from all websites 10, and it is determined in step 6 whether or not any image data has been updated.

In the case of FIG. 16, each image data is managed by appending date to its file name. For instance, the image data acquired on the previous day “02/21/2020” is managed as “AAAAA_0221” image, and the image data acquired on today “2020/02/22” is managed as “AAAAA_0222” image.

In the table illustrated in FIG. 16, the matching rate between the image data acquired on the previous day and the newly acquired image data is added.

In the case of FIG. 16, the matching rate of the “AAAAA_0222” image included in “ttta” site of the “aaa service” has been reduced to 95%. In addition, the matching rate of the “BBBBB_0222” image included in “tttb” site of the “aaa service” has been reduced to 50%. Therefore, these two pieces of image data are extracted in step 6, and saved as the updated image data 42B.

The description is returned to FIG. 11.

The CPU 41A determines the presence or absence of update of document data stored in the document data DB 30 (step 4).

When update of document data is recorded, the CPU 41A obtains an affirmative result in step 4. In this case, the CPU 41A compares the image data acquired in the previous acquisition time with the image data with update found among the image data acquired from the website 10 (step 8).

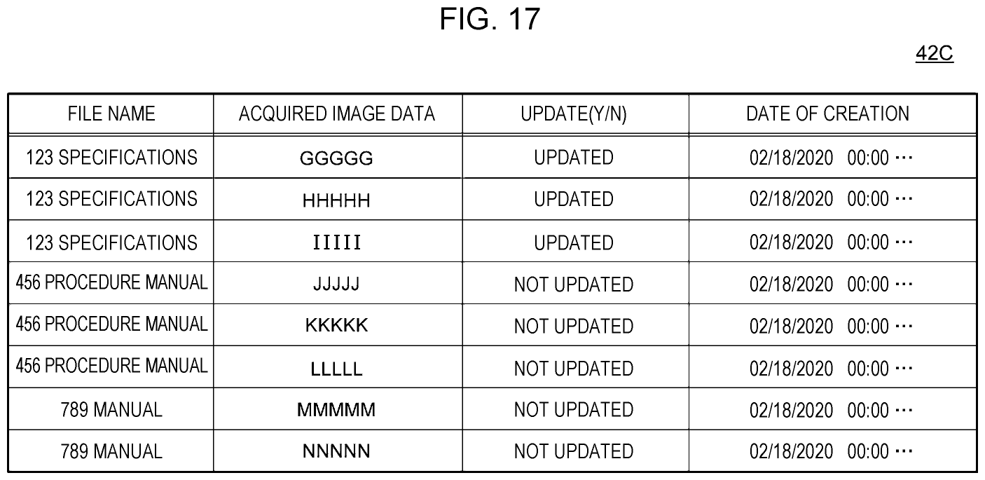

FIG. 17 is a view illustrating an example of acquired image data 42C when the image data is acquired from the document data for the second and subsequent time. In FIG. 17, a corresponding symbol is labeled and shown for a corresponding portion with FIG. 13.

In the case of FIG. 17, “updated” is recorded for the “GGGGG” image of the “123 specifications”, the “HHHHH” image of the specifications, and the “IIIII” image of the specifications.

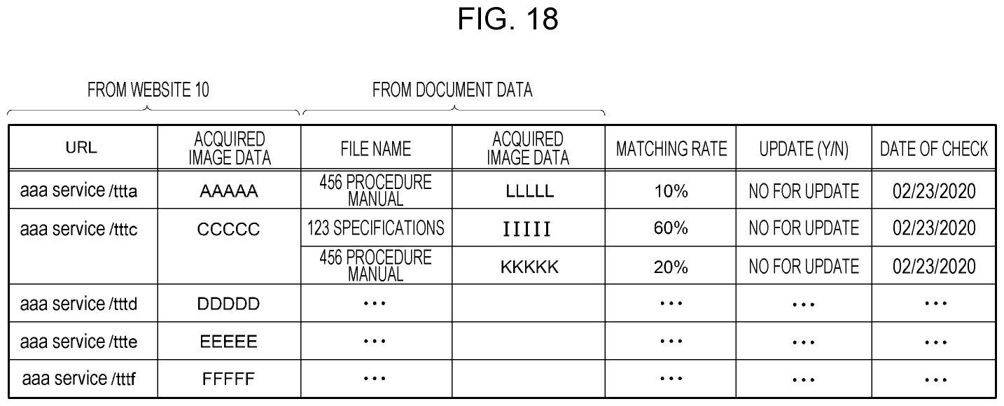

FIG. 18 is a view illustrating an example of management data registered according to checking by the administrator in the previous time. In FIG. 18, a corresponding symbol is labeled and shown for a corresponding portion with FIG. 15.

The management data illustrated in FIG. 18 corresponds to the information on the image data to which instructions for “not updated” are given in FIG. 15.

The description is returned to FIG. 11.

In step 8, the CPU 41A compares the latest image data acquired from the document data with the updated image data among the image data acquired from the website 10.

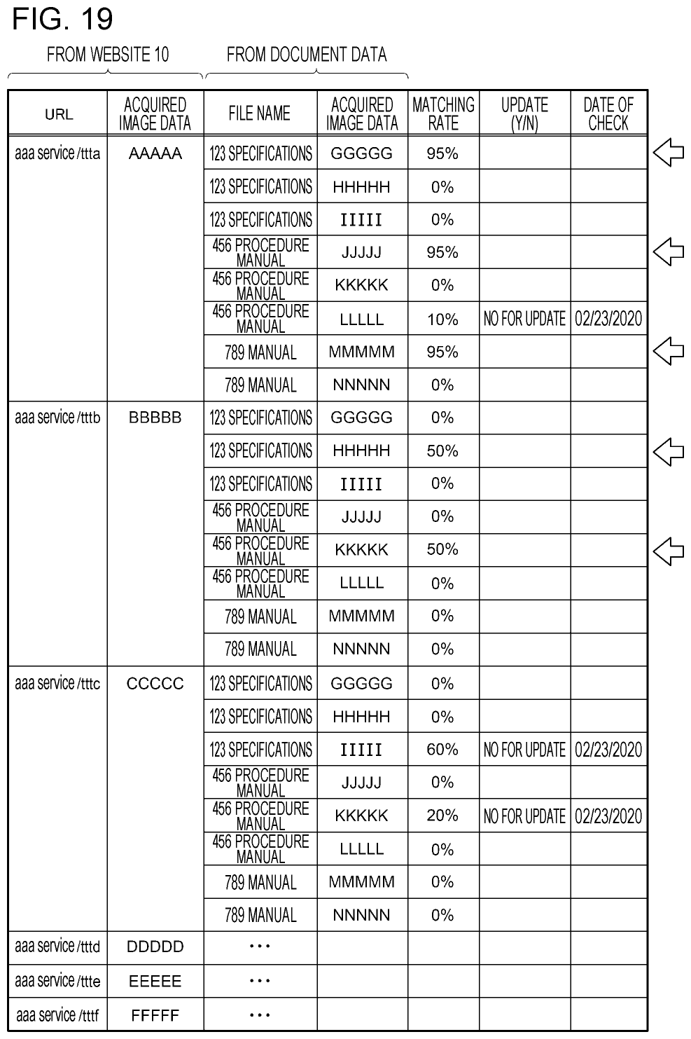

FIG. 19 is a view illustrating an example of a result of comparison between the image data acquired in the website 10 and the image data acquired in the document data. In FIG. 19, a corresponding symbol is labeled and shown for a corresponding portion with FIG. 14.

FIG. 19 shows the case where the matching rate is 100% or 0%, or the administrator has given instructions for “not updated” in the previous checking except for the rows indicated by an arrow.

For instance, for the “LLLLL” image of the “456 procedure manual”, although the matching rate with the “AAAAA” image is 10%, an arrow is not labeled. Similarly, for the “IIIII” image of the “123 specifications”, although the matching rate with the “CCCCC” image is 60%, an arrow is not labeled. In addition, for the “KKKKK” image of the “456 procedure manual”, although the matching rate with the “CCCCC” image is 20%, an arrow is not labeled.

Thus, the administrator is notified of five images: the “GGGGG” image of the “123 specifications”, the “JJJJJ” image of the “456 procedure manual”, the “MMMMM” image of the “789 manual”, the “HHHHH” image of the “123 specifications”, and the “KKKKK” image of the “456 procedure manual”.

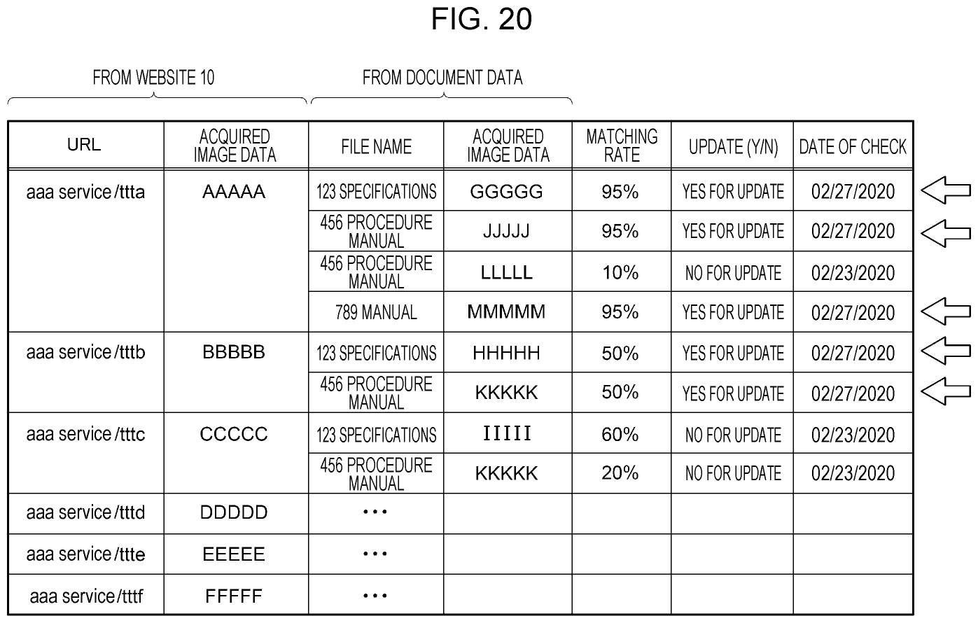

FIG. 20 is a view illustrating an example of a result of receiving the necessity or unnecessity of update of image data determined by the administrator.

The case of FIG. 20 shows a state where “updated” is selected for the five images newly notified to the administrator.

Like this, when image data updated on the website 10 is provided, the administrator can determine the necessity of update of the image data included in corresponding document data with less effort. In addition, the possibility of overlooking an image data to be updated is also reduced.

### Other Exemplary Embodiments

Although the exemplary embodiment of the present disclosure has been described above, the technical scope of the present disclosure is not limited to the scope described in the exemplary embodiment. It is apparent from the description within the scope of the claims that the above-described exemplary embodiment to which various modifications and improvements are made is also included in the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire first image data including update from a website which is an object to be monitored,
acquire second image data from document data which is an object to be monitored, and
compare the first image data with the second image data, and notify an administrator for the document data of a section with possibility of change.

2. The information processing apparatus according to claim 1, wherein the processor is configured to, when a matching rate between the first image data and the second image data satisfies a predetermined condition, notify the administrator of the second image data as the section with possibility of change.

3. The information processing apparatus according to claim 2, wherein the predetermined condition is that the matching rate is lower than a first threshold.

4. The information processing apparatus according to claim 3, wherein the predetermined condition is that the matching rate is higher than a second threshold which is lower than the first threshold.

5. The information processing apparatus according to claim 4, wherein the processor is configured to, when the matching rate is lower than the second threshold, exclude the second image data from an object of which the administrator is notified.

6. The information processing apparatus according to claim 1, wherein the processor is configured to request the administrator to check necessity of modification of the second image data that is an object of which the administrator is notified.

7. The information processing apparatus according to claim 6, wherein the processor is configured to exclude the second image data for which no need of modification is determined, from an object to be compared subsequently.

8. An information processing apparatus comprising:
means for acquiring first image data including update from a website which is an object to be monitored;
means for acquiring second image data from document data which is an object to be monitored; and
means for comparing the first image data with the second image data, and notify an administrator for the document data of a section with possibility of change.
